(19) United States
(12) Patent Application Publication
(10) Pub. No.: US 2016/0049729 A1
(43) Pub. Date: Feb. 18, 2016

(54) ANTENNA STRUCTURE

(71) Applicant: RAINSUN CO., LTD., Taoyuan County (TW)

(72) Inventors: YUAN-HAN CHAN, TAICHUNG CITY (TW); CHENG-LEI LEE, TAOYUAN COUNTY (TW)

(21) Appl. No.: 14/457,225

(22) Filed: Aug. 12, 2014

(51) Int. Cl. H01Q 7/00

(52) U.S. Cl. CPC H01Q 7/00

(57) ABSTRACT

An antenna structure includes an antenna, a first bonding film, and a second bonding film. The antenna is bendable and has a main segment, a first connecting segment connected to the main segment, and a second connecting segment connected to the main segment. The antenna has a first surface and an opposite second surface, and the first and the second connecting segments are respectively configured to connect a ground and a signal source. Each one of the first bonding film and the second bonding film has an adhesive surface and is bendable. The first and second surfaces of the main segment are respectively adhered on the adhesive surfaces of the first and second bonding films. The adhesive surface of the first bonding film is adhered on the adhesive surface of the second bonding film, and the main segment is encapsulated between the first and second bonding films.

### BACKGROUND OF THE INVENTION

1. Field of the Invention

The instant disclosure relates to an antenna structure; more particularly, to an antenna structure without any printed circuit board (PCB) or any flexible printed circuit (FPC) board.

2. Description of Related Art

An antenna of the conventional antenna structure is formed on a printed circuit board or a flexible printed circuit board. Thus, the manufacturing process of the conventional antenna structure tends to include an etching process, in which the process easily pollutes the environment and increases the cost of the conventional antenna structure.

To achieve the abovementioned improvement, the inventors strive via industrial experience and academic research to present the instant disclosure, which can provide additional improvement as mentioned above.

### SUMMARY OF THE INVENTION

One embodiment of the instant disclosure provides an antenna structure without an antenna on any printed circuit board or any flexible printed circuit board, thereby reducing the cost of the antenna structure and preventing the environment from pollution.

The antenna structure provided by the instant disclosure comprises: a bendable antenna having a main segment, a first connecting segment connected to the main segment, and a second connecting segment connected to the main segment, wherein the antenna has a first surface and an opposite second surface, the first and the second connecting segments are respectively configured for connecting a ground and a signal source; a bendable first bonding film having an adhesive surface, wherein the first surface of the main segment is adhered on the adhesive surface of the first bonding film; and a bendable second bonding film having an adhesive surface, wherein the second surface of the main segment is adhered on the adhesive surface of the second bonding film, the adhesive surface of the first bonding film is adhered on the adhesive surface of the second bonding film, and the main segment is encapsulated between the first and second bonding films.

Preferably, the first connecting segment has a bonding portion, an externally connecting portion, and a crossing portion connecting the bonding portion and the externally connecting portion, the bonding portion of the first connecting segment is connected to the main segment, the crossing portion of the first connecting segment is arranged across the first surface of the main segment, and wherein the second connecting segment has a bonding portion and an externally connecting portion integrally extended from the bonding portion thereof, the bonding portion of the second connecting segment is connected to the main segment, the externally connecting portions of the first and second connecting segments are exposed from the first bonding film.

Preferably, the main segment, the first connecting segment, and the second connecting segment are integrally formed in one piece, the main segment is a planar coil, the first connecting segment is connected to an inner end of the main segment, the first connecting segment is arranged across the first surface of the main segment by bending with respect to the main segment, the second connecting segment is connected to an outer end of the main segment, and wherein a portion of the first connecting segment overlapped with the first surface of the main segment is a crossing portion, the antenna has an insulating layer arranged between the crossing portion and a portion of the first surface of the main segment correspondingly overlapping with the crossing portion.

In summary, the antenna structure of the instant disclosure is provided with the antenna encapsulated by the first bonding film and the second bonding film, so that the antenna of the instant disclosure does not need to be formed on the printed circuit board or the flexible printed circuit board as conventional antenna, thereby reducing the cost of the antenna structure and preventing the environment from pollution. The material cost of the antenna structure of the instant disclosure is lower than the conventional antenna structure, and the antenna structure of the instant disclosure is easily produced by automatic process.

Moreover, the antenna of the instant disclosure can be protected to prevent damage from the external environment (e.g., oxidation) by being encapsulated between the first bonding film and the second bonding film. Additionally, when the main segment, the first connecting segment, and the second connecting segment of the antenna are integrally formed in one piece, the manufacturing process of the antenna structure in the instant embodiment is easier than the first embodiment. As a result, the antenna structure of the instant embodiment can be produced much quicker to reduce cost.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a perspective view of an antenna structure according to a first embodiment of the instant disclosure;

FIG. 2 is an explosive view of FIG. 1;

FIG. 3 is an explosive view of FIG. 1 in another viewing angle;

FIG. 4 is a cross-sectional view of FIG. 1 along the line 4-4;

FIG. 5 is a cross-sectional view of FIG. 1 along the line 5-5;

FIG. 6 is a cross-sectional view of FIG. 1 along the line 6-6;

FIG. 7 is a perspective view of the step S101 of the manufacturing method of the antenna structure according to the first embodiment of the instant disclosure;

FIG. 8 is a perspective view of the step S103 of the manufacturing method of the antenna structure according to the first embodiment of the instant disclosure;

FIG. 9 is a perspective view of the step S105 of the manufacturing method of the antenna structure according to the first embodiment of the instant disclosure;

FIG. 10 is a perspective view of the step S107 of the manufacturing method of the antenna structure according to the first embodiment of the instant disclosure;

FIG. 11 is a perspective view of the step 5201 of the manufacturing method of the antenna structure according to a second embodiment of the instant disclosure;

FIG. 12 is a perspective view of the step 5203 of the manufacturing method of the antenna structure according to the second embodiment of the instant disclosure before bending a first connecting segment;

FIG. 13 is a perspective view of the step 5203 of the manufacturing method of the antenna structure according to the second embodiment of the instant disclosure after bending the first connecting segment;

FIG. 14 is a perspective view of the step 5205 of the manufacturing method of the antenna structure according to a second embodiment of the instant disclosure; and

FIG. 15 is a perspective view of the antenna structure according to the second embodiment of the instant disclosure.

### DETAILED DESCRIPTION OF THE PREFERRED EMBODIMENTS

### First Embodiment

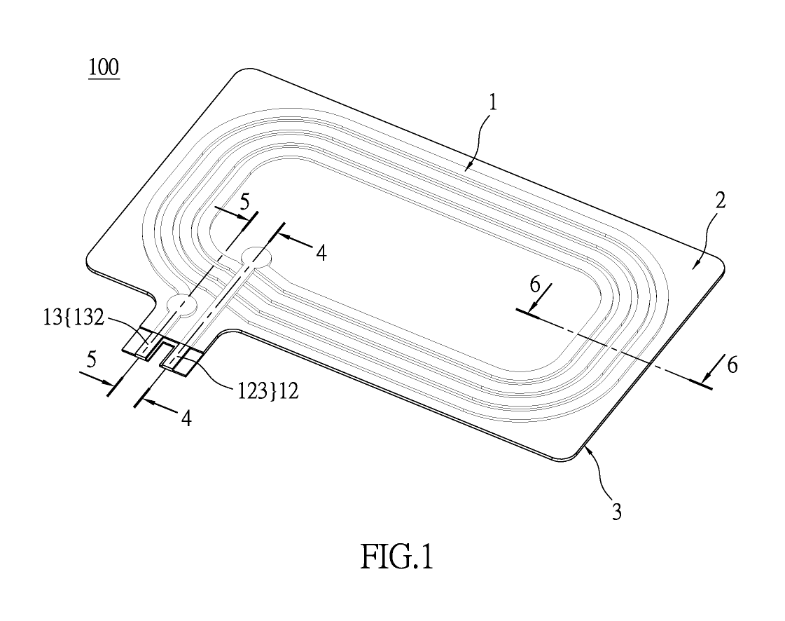

Please refer to FIGS. 1 through 10, which show an embodiment of the instant disclosure. References are hereunder made to the detailed descriptions and appended drawings in connection with the instant disclosure. However, the appended drawings are merely shown for exemplary purposes, rather than being used to restrict the scope of the instant disclosure.

Please refer to FIG. 1, the instant embodiment discloses an antenna structure 100 for near field communication (NFC), but is not limited thereto. The antenna structure 100 has a bendable antenna 1, a bendable first bonding film 2, and a bendable second bonding film 3. The antenna 1 is approximately encapsulated between the first bonding film 2 and the second bonding film 3. The following description discloses each construction of the antenna 1, the first bonding film 2, and the second bonding film 3, and then further explains the relationship between the above components.

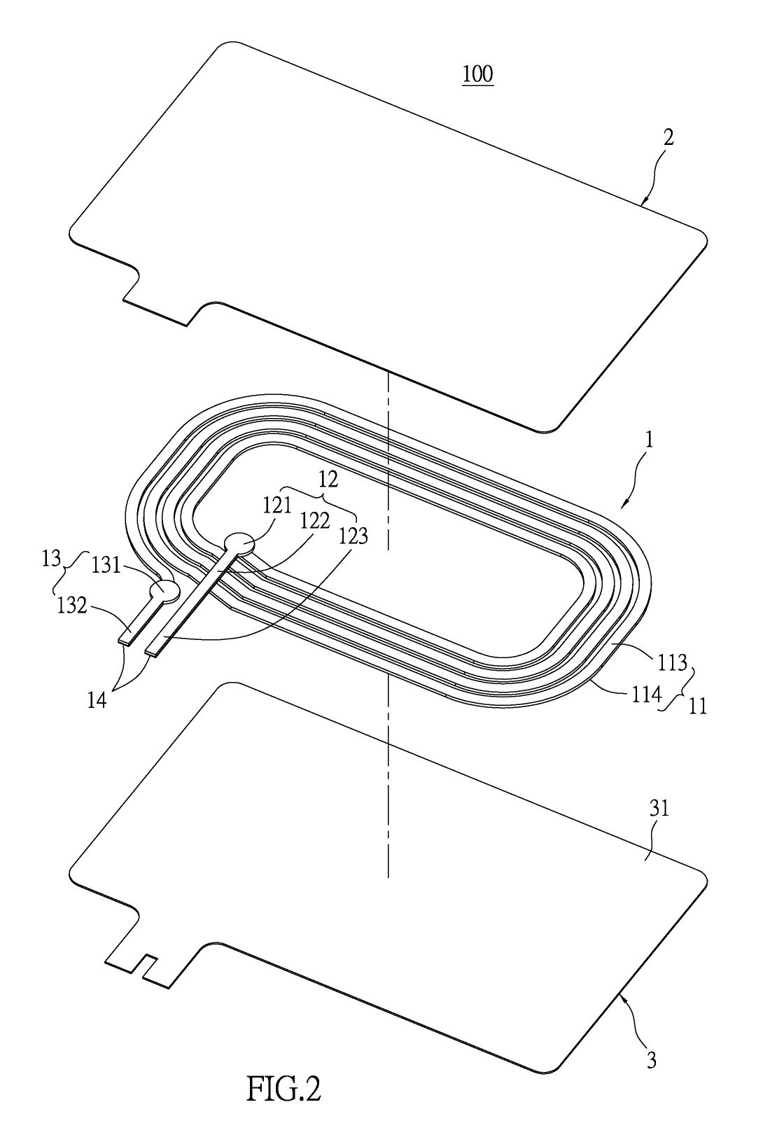

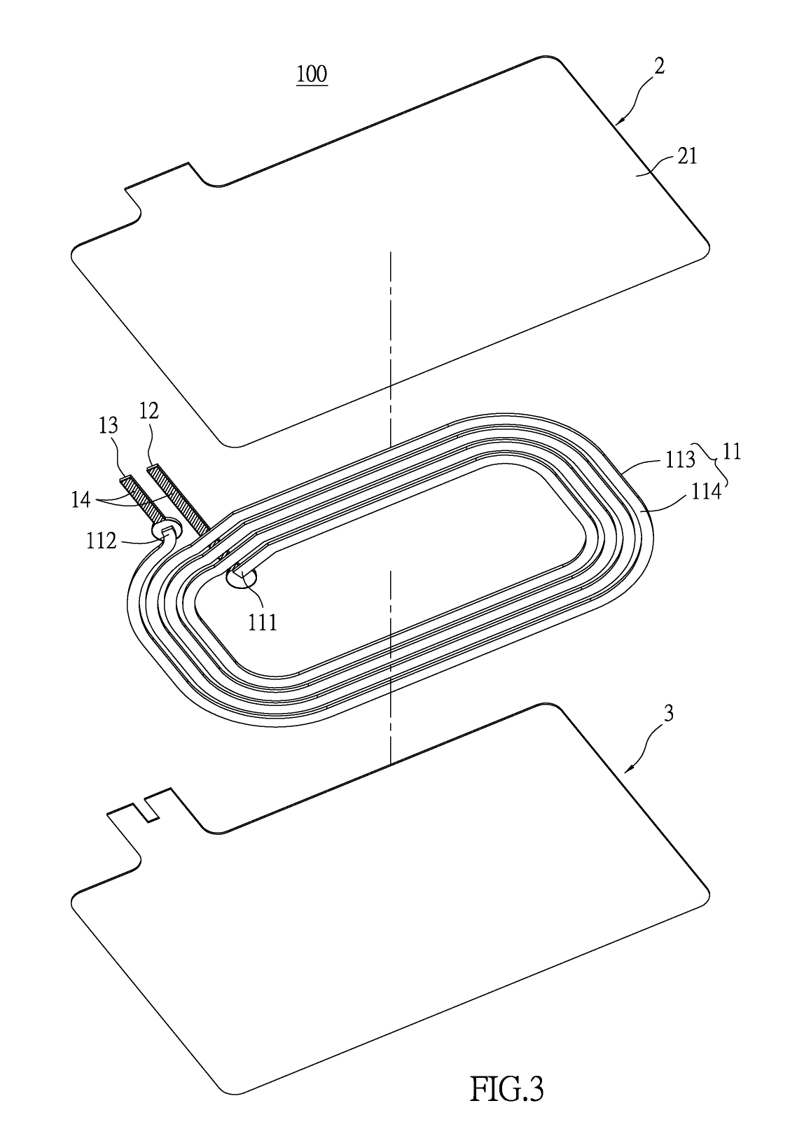

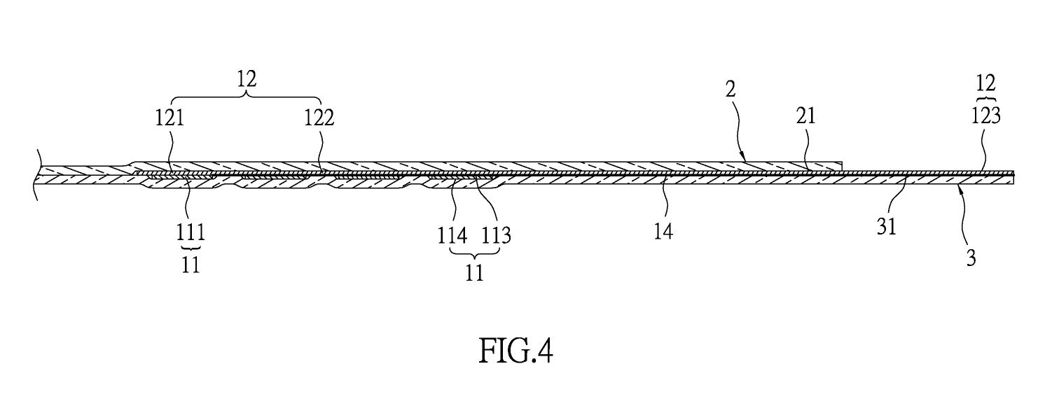

Please refer FIGS. 2 and 3, and occasionally refer to FIGS. 4 through 6. The antenna 1 has a main segment 11, a first connecting segment 12 connected to the main segment 11, a second connecting segment 13 connected to the main segment 11, and two insulating layers 14 respectively formed on the first connecting segment 12 and the second connecting segment 13. The main segment 11, the first connecting segment 12, and the second connecting segment 13 are made of metal (e.g., copper or aluminum), each of the main segment 11, the first connecting segment 12, and the second connecting segment 13 has a thickness about 5-25 μm (i.e., the instant takes 10 μm for example), but the material and the thickness are not limited thereto.

The main segment 11 in the instant embodiment is a planar coil. The main segment 11 has an inner end 111 and an outer end 112. That is to say, the inner end 111 is arranged inside the main segment 11, the outer end 112 is arranged outside the main segment 11, and the inner end 111 is arranged adjacent to the outer end 112, but not limited thereto. Moreover, the main segment 11 has a first surface 113 and an opposite second surface 114, and the first surface 113 and the second surface 114 are arranged on two opposite surfaces of the main segment 11 (i.e., the top surface and the bottom surface of the main segment 11 as shown in FIG. 2).

The first connecting segment 12 shapes like a straight line. The first connecting segment 12 has a bonding portion 121, an externally connecting portion 123, and a crossing portion 122 connecting the bonding portion 121 and the externally connecting portion 123. The second connecting segment 13 shapes like a straight line, and the length of the second segment 13 is smaller than the first connecting segment 12. The second connecting segment 13 has a bonding portion 131 and an externally connecting portion 132 integrally extended from the bonding portion 131. Moreover, the two insulating layers 14 are respectively formed on a surface of the first connecting segment 12 (i.e., the bottom surface of the first connecting segment 12 as shown in FIG. 2) and a surface of the second connecting segment 13 (i.e., the bottom surface of the second connecting segment 13 as shown in FIG. 2).

Notably, one of the insulating layers 14 formed on the bottom surface of the first connecting segment 12 has a specific purpose. The reason of the insulating layers 14 formed on the bottom surface of the second connecting segment 13 is disclosed as follows. The first connecting segment 12 and the second connecting segment 13 are cut from the same metallic sheet (not shown). Specifically, the first connecting segment 12 and the second connecting segment 13 are cut from a metallic sheet 201. Before cutting the metallic sheet 201, an insulating layer 14 is formed on one surface of the metallic sheet. After cutting, the first connecting segment 12 and the second connecting segment 13 each has an insulating layer 14 formed on the bottom surfaces thereof.

Moreover, the bonding portion 121 of the first connecting segment 12 is connected to (i.e., welded on) the first surface 113 of the inner end 111 of the main segment 11. The crossing portion 122 of the first connecting segment 12 is arranged across the first surface 113 of the main segment 11, so that two opposite ends of the first connecting segment 12 (i.e., the bonding portion 121 and the externally connecting portion 123) are respectively arranged at the inner side and the outer side of the main segment 11.

The bonding portion 131 of the second connecting segment 13 is connected to (i.e., welded on) the first surface 113 of the outer end 112 of the main segment 11. The second connecting segment 13 is arranged adjacent to the first connecting segment 12, and the second connecting segment 13 is substantially parallel to the first connecting segment 12. The end of the externally connecting portion 132 of the second connecting segment 13 substantially aligns with the end of the externally connecting portion 123 of the first connecting segment 12. Thus, the first and the second connecting segments 12, 13 can respectively connect to a ground and a signal source.

Notably, the “connecting” between the main segment 11 and the first connecting segment 12 or the “connecting” between the main segment 11 and the second connecting segment 13 can be established through welding as disclosed in the first embodiment, whereas the “connecting” in the following second embodiment, or the other non-shown manner can be established through integral extension as disclosed below.

The first bonding film 2 in the instant embodiment has substantially a rectangular shape and is a heat-resistant plastic film. The first bonding film 2 must be large enough to entirely cover the main segment 11 of the antenna 1. The first bonding film 2 has an adhesive surface 21 (i.e., the bottom surface of the first bonding film 2 as shown in FIG. 3).

The second bonding film 3 in the instant embodiment has substantially a rectangular shape and is a heat-resistant plastic film, and the material of the second bonding film 3 can be identical to or different from the material of the first bonding film 2. The second bonding film 3 must be large enough to entirely cover the main segment 11 of the antenna 1, and the shape of the second bonding film 3 is substantially identical to the shape of the first bonding film 2. The second bonding film 3 has an adhesive surface 31 (i.e., the top surface of the second bonding film 3 as shown in FIG. 2).

The first surface 113 of the main segment 11 is adhered on the adhesive surface 21 of the first bonding film 2, the second surface 114 of the main segment 11 is adhered on the adhesive surface 31 of the second bonding film 3, and the adhesive surface 21 of the first bonding film 2 is substantially adhered on the adhesive surface 31 of the second bonding film 3. The contour of the first bonding film 2 substantially aligns with the contour of the second bonding film 3.

In other words, a portion of the adhesive surface 21 of the first bonding film 2 not adhering to the antenna 1 is substantially adhered on a portion of the adhesive surface 31 of the second bonding film 3 not adhering to the antenna 1, and the main segment 11 is encapsulated between the first and second bonding films 2, 3. As shown in FIG. 6, a portion of the adhesive surface 21 of the first bonding film 2 and a portion of the adhesive surface 31 of the second bonding film 3, which correspond to a gap arranged between any two adjacent turns of the main segment 11, are adhered to each other in order to effectively maintain the overall shape of the main segment 11.

Moreover, the bonding portion 121 and the crossing portion 122 of the first connecting segment 12 and the bonding portion 131 of the second connecting segment 13 are encapsulated between the first bonding film 2 and the second bonding film 3. The externally connecting portion 123 of the first connecting segment 12 is exposed from the first bonding film 2 or the second bonding film 3, and the externally connecting portion 132 of the second connecting segment 13 is exposed from the first bonding film 2 or the second bonding film 3.

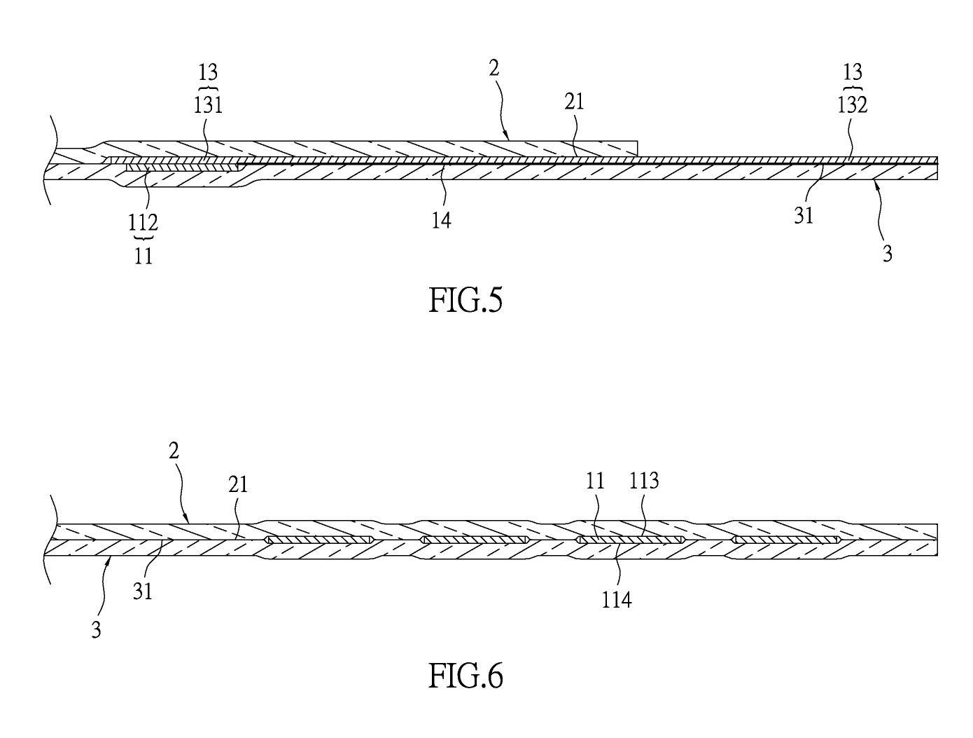

Specifically, the instant embodiment as shown in FIGS. 4 and 5, one of the insulating layers 14 is formed on a surface of the crossing portion 122 and a surface of the externally connecting portion 123, which are arranged on surfaces away from the first bonding film 2. Another insulating film 14 is formed on a surface of the externally connecting portion 132, which is arranged the surface away from the first bonding film 2. The insulating layers 14 formed on the externally connecting portions 123, 132 are adhered on the second bonding film 3. The surfaces of the externally connecting portions 123, 132 exposed from the first bonding film 2 are respectively connected to a ground and a signal source.

As shown in FIG. 4, the antenna 1 in the instant embodiment has one insulating layer 14 arranged between the crossing portion 122 and a portion of the first surface 113 of the main segment 11 correspondingly overlapping with the crossing portion 13. Specifically, the insulating layer 14 needs to be formed on a surface of the crossing portion 122 away from the first bonding film 2 (i.e., the bottom surface of the crossing portion 122 as shown in FIG. 4), thus providing electrical isolation between the crossing portion 122 of the first connecting segment 12 and the main segment 11. Thus, the first connecting segment 12 of the antenna structure 100 can be arranged across the main segment 11 on a single side.

The insulating layer 14 formed on the crossing portion 122 at least partially abuts the first surface 113 of the main segment 11. A portion of the insulating layer 14, which is formed on the crossing portion 122 and not abutting the first surface 113, is approximately adhered on the adhesive surface 31 of the second bonding film 3. Specifically, a portion of the first bonding film 2 and a portion of the second bonding film 3, which correspond to the main segment 11, are slightly protruding to shape as a wave-like surface (as shown in FIGS. 4 and 6).

Thus, the antenna structure 100 of the instant embodiment encapsulates the antenna 1 with the first bonding film 2 and the second bonding film 3, so that the antenna 1 of the instant embodiment need not be formed on the printed circuit board or the flexible printed circuit board as conventional antenna do, thus reducing the cost of the antenna structure 100 and preventing the environment from pollution.

Moreover, the antenna 1 can be protected to prevent damage from the external environment (e.g., oxidation) by having the antenna 1 encapsulated between the first bonding film 2 and the second bonding film 3.

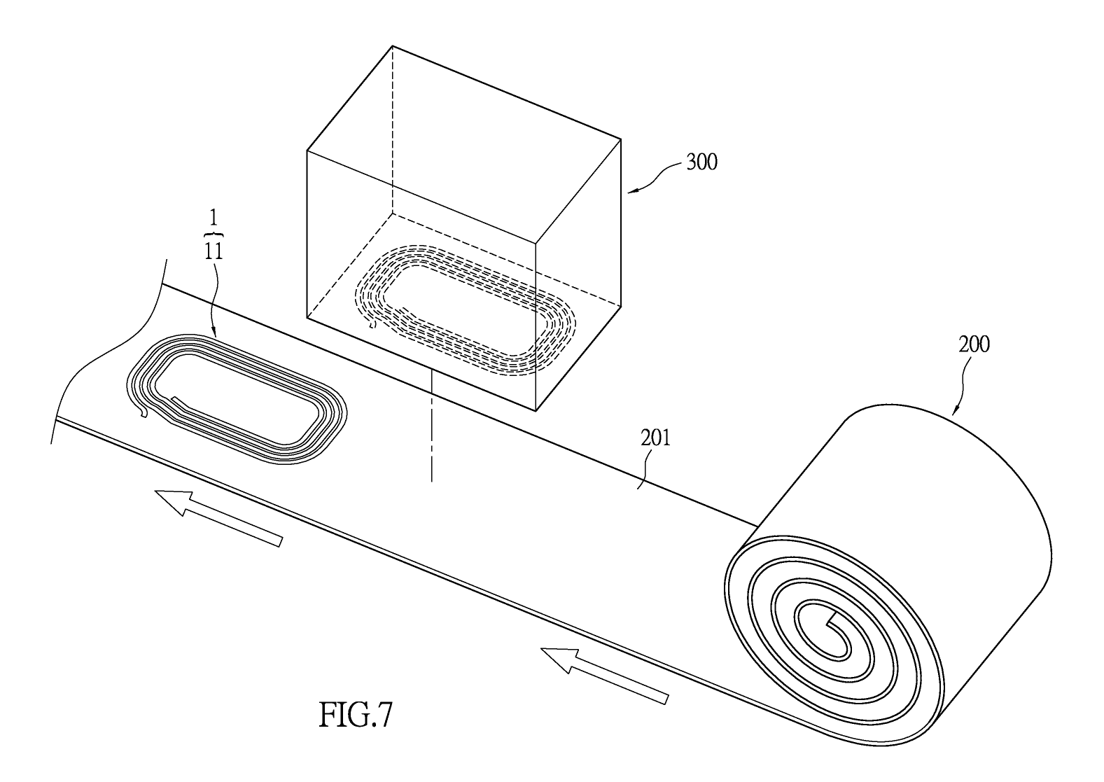

The above description is about the construction of the antenna structure 100. In order to easily understanding the effect of the antenna structure 100, the following description discloses the manufacturing method of the antenna structure 100. Please refer to FIGS. 7 through 10, which show the steps of the manufacturing method of the antenna structure 100.

The step S101: as shown in FIG. 7, providing a material supplying unit 200 and a cutting mold 300. The material supplying unit 200 provides a metallic sheet 201 along a material supplying path, and the cutting mold 300 is arranged above the material supplying path. The cutting mold 300 has a cutting construction. The cutting construction conforms to the main segment 11 of the antenna 1 and faces the metallic sheet 201 which is arranged in the material supplying path.

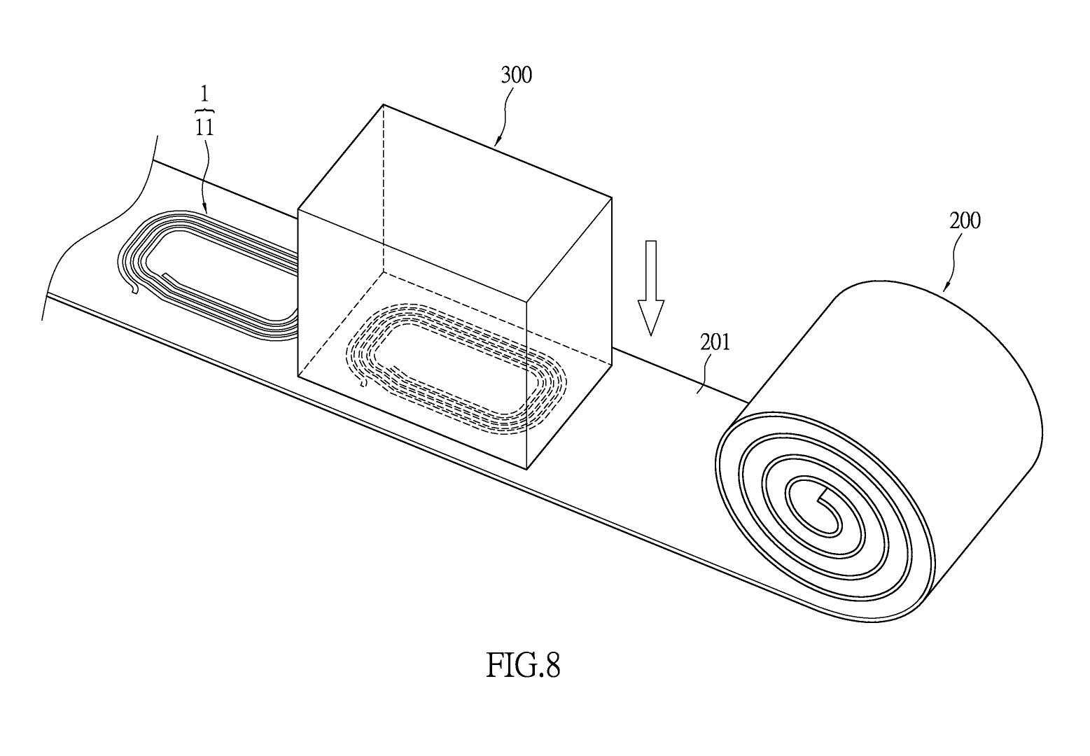

The step S103: as shown in FIG. 8, when the material supplying unit 200 continuously outputs the metallic sheet 201, the cutting mold 300 punches the metallic sheet 201 to form the main segment 11 of the antenna 1 by the cutting construction. Specifically, the cutting mold 300 punches the metallic sheet 201 back and forth, thus continuously forming a plurality of the main segments 11 from the metallic sheet 201. The main segments 11 can be transported from the metallic sheet 201 by a transporting device (not shown).

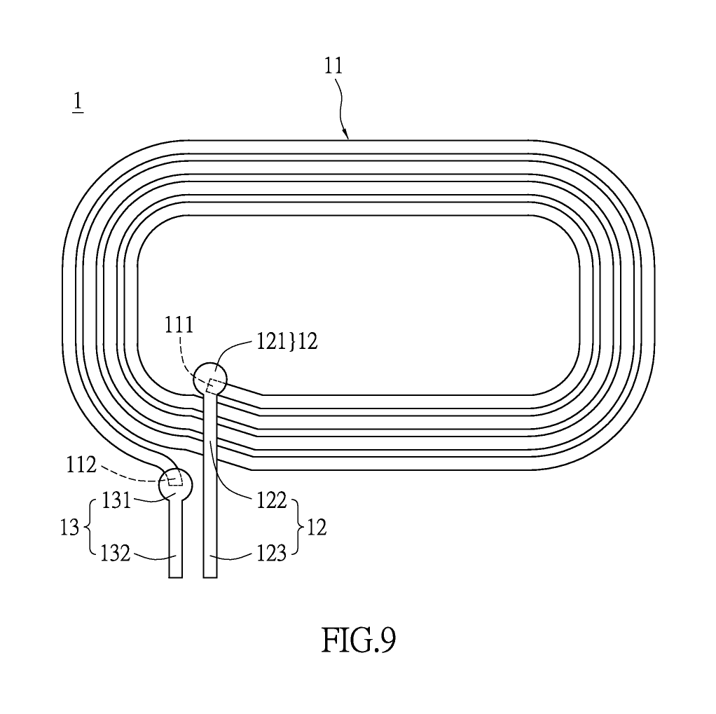

The step S105: as shown in FIG. 9, welding the bonding portion 121 of the first connecting segment 12 to the inner end 111 of the main segment 11, and arranging the crossing portion 122 across the main segment 11 in order to arrange the externally connecting portion 123 outside the main segment 11; welding the bonding portion 131 of the second connecting segment 13 to the outer end 112 of the main segment 11, and arranging the externally connecting portion 132 adjacent to the externally connecting portion 123. Thus, after the step S 105, the antenna 1 is produced.

Notably, the manufacturing of the first connecting segment 12, the second connecting segment 13, and the insulating layer 14 is disclosed in the above description, such that the corresponding manufacturing steps are not disclosed again.

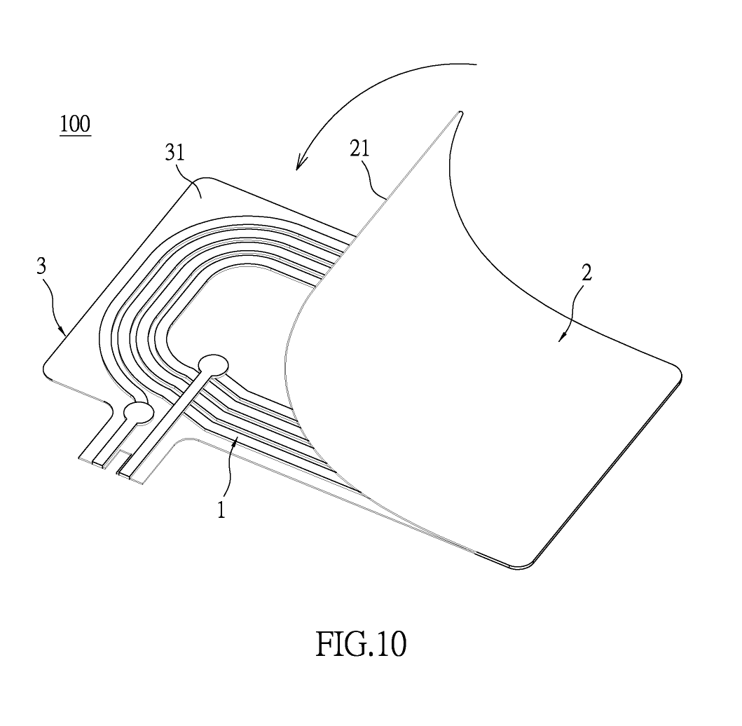

The step S107: as shown in FIG. 10, adhering two opposite surfaces of the antenna 1 (i.e., the top surface and the bottom surface of the antenna 1 as shown in FIG. 10) on the adhesive surface 21 of the first bonding film 2 and the adhesive surface 31 of the second bonding film 3 respectively, thus providing the antenna structure 100 (as shown in FIG. 1). It should be noted that, when implementing the step S107, the adhering portion of the first and second bonding films 2, 3 should avoid generating bubbles. For example, the user can use roller to press the adhering portion of the first and second bonding films 2, 3 to avoid bubble generation, but is not limited thereto.

According to the above steps, the manufacturing of the antenna structure 100 of the instant embodiment does not need any high pollution process (e.g., etching process), thus reducing the cost of the antenna structure and preventing the environment from pollution. Moreover, the material cost of the antenna structure 100 is lower than the conventional antenna structure, and the antenna structure 100 of the instant embodiment is easily produced by automatic process.

### Second Embodiment

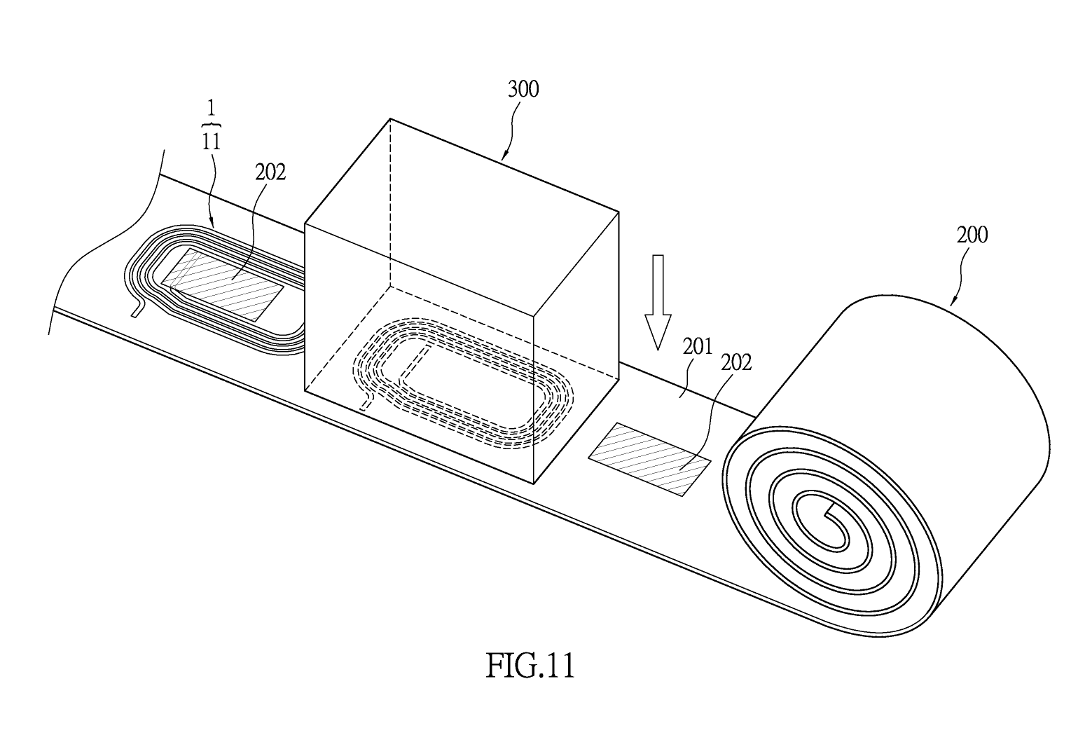

Please refer to FIGS. 11 through 15, which show a second embodiment of the instant disclosure. The second embodiment is similar to the first embodiment, so that the same features are not disclosed again. The difference between the first and second embodiments is that the main segment 11, the first connecting segment 12, and the second connecting segment 13 of the second embodiment are integrally formed in one piece. That is to say, the bonding portion 121 of the first connecting segment 12 is integrally extended from the inner end 111 of the main segment 11, and the bonding portion 131 of the second connecting segment 13 is integrally extended from the outer end 112 of the main segment 11.

In order to easily understanding the antenna structure 100 of the instant embodiment, the following description discloses the manufacturing method of the antenna structure 100. Please refer to FIGS. 11 through 14, which show the steps of the manufacturing method of the antenna structure 100.

The step S201: as shown in FIG. 11, providing a material supplying unit 200 and a cutting mold 300. The material supplying unit 200 provides a metallic sheet 201 along a material supplying path, and the cutting mold 300 is arranged above the material supplying path. An insulating paint 202 is coated on a predetermined area of the metallic sheet 201. The cutting mold 300 has a cutting construction, and the cutting construction conforms to the main segment 11, the first connecting segment 12, and the second connecting segment 13 of the antenna 1 and faces the metallic sheet 201 arranged in the material supplying path.

Moreover, when the material supplying unit 200 continuously outputs the metallic sheet 201, the cutting mold 300 punches the metallic sheet 201 to form the main segment 11, the first connecting segment 12, and the second connecting segment 13 of the antenna 1 by the cutting construction. Specifically, the cutting mold 300 punches the metallic sheet 201 back and forth, thus continuously forming a plurality of the antennas continuously from the metallic sheet 201.

Notably, when the cutting mold 300 punches the metallic sheet 201, a portion of the cutting construction corresponding to the first connecting segment 12 is pressed on the predetermined area of the metallic sheet 201 to form the connecting segment 12 with the insulating layer 14.

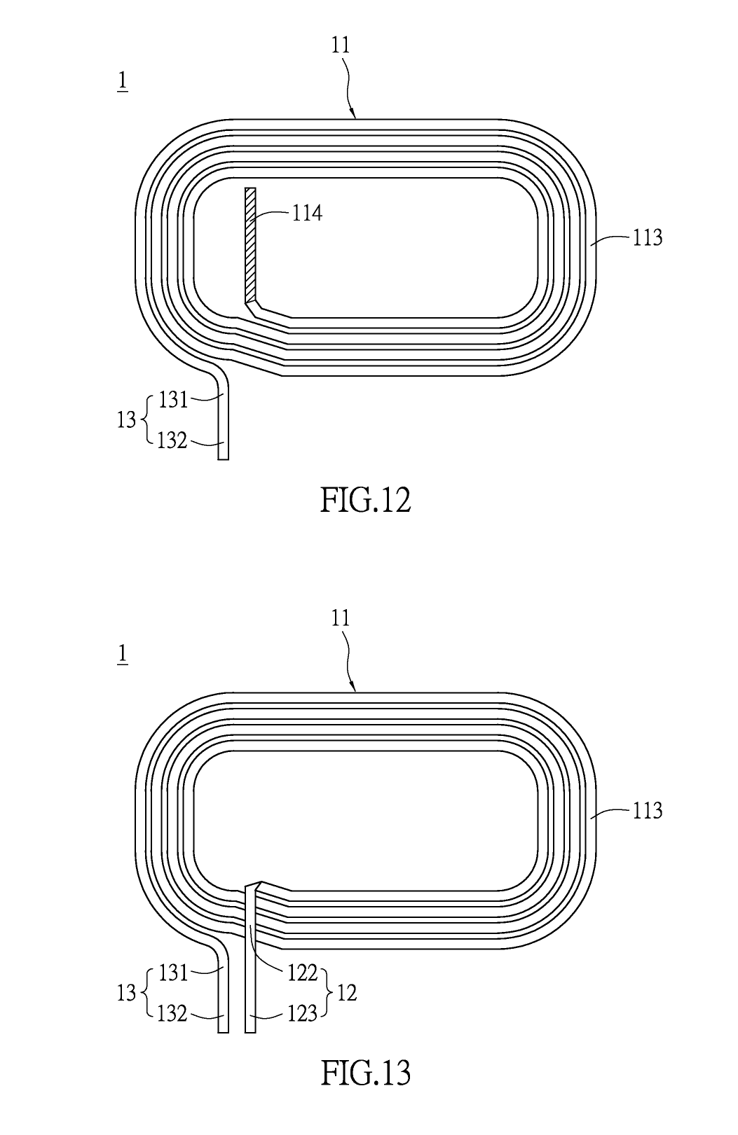

The first connecting segment 12 is arranged inside the main segment 11, and the second connecting segment 13 is arranged outside the main segment 11. Moreover, the antennas 11 can be transported from the metallic sheet 201 by a transporting device (not shown), and each antenna 11, which is cut from the metallic sheet 201, is shown as FIG. 12.

The step S203: as shown in FIGS. 12 and 13, outwardly folding the first connecting segment 12 to make the crossing portion 122 across the main segment 11 so as to arrange the externally connecting portion 123 outside the main segment 11. After folding the first connecting segment 12, the externally connecting portion 123 is arranged adjacent to the externally connecting portion 132, and the first connecting segment 12 is substantially parallel to the second connecting segment 13. Thus, after the step S203, the antenna 1 is produced.

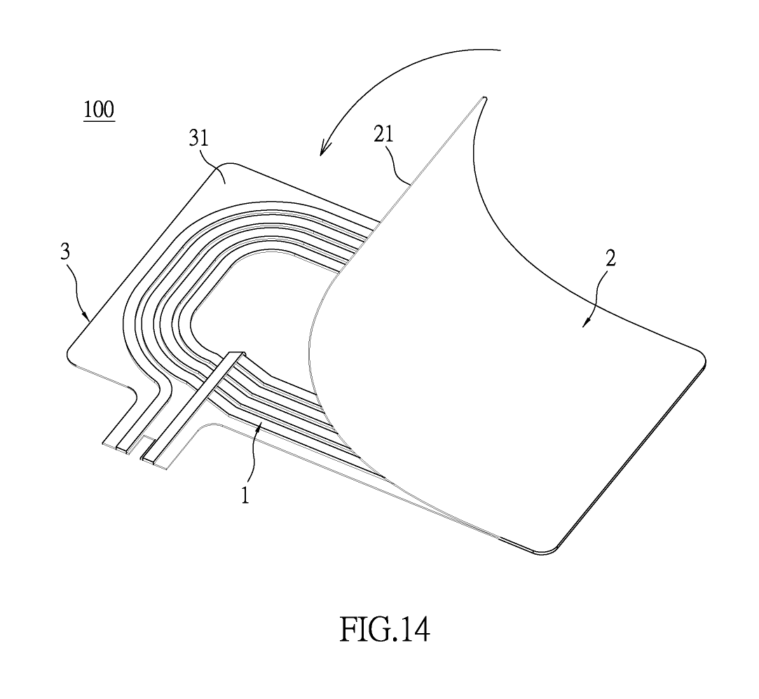

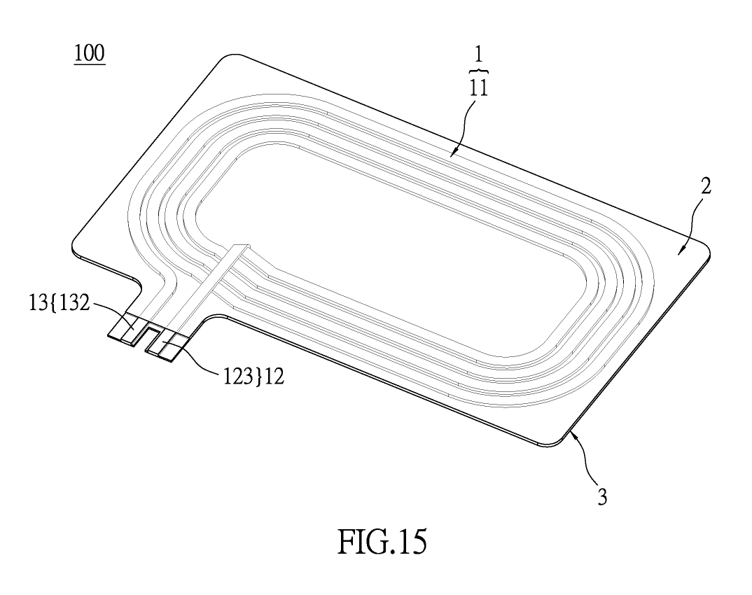

The step S205: as shown in FIG. 14, adhering two opposite surfaces of the antenna 1 (i.e., the top surface and the bottom surface of the antenna 1 as shown in FIG. 14) on the adhesive surface 21 of the first bonding film 2 and the adhesive surface 31 of the second bonding film 3 respectively, thus providing the antenna structure 100 (as shown in FIG. 15). It should be noted that, when implementing the step S205, the adhering portion of the first and second bonding films 2, 3 should avoid generating bubbles. For example, the user can use roller to press the adhering portion of the first and second bonding films 2, 3 to avoid bubble generation, but is not limited thereto.

According to the above steps, the manufacturing of the antenna structure 100 of the instant embodiment does not need any high pollution process (e.g., etching process), thus reducing the cost of the antenna structure and preventing the environment from pollution. Moreover, the material cost of the antenna structure 100 is lower than the conventional antenna structure, and the antenna structure 100 of the instant embodiment is easily to produced by automatic process. Additionally, the manufacturing process of the antenna structure 100 of the instant embodiment is easier than the first embodiment, so that the antenna structure 100 of the instant embodiment can be produced much quicker to reduce cost.

### The Possible Effects of the Instant Embodiment

In summary, the antenna structure of the instant disclosure is provided with the antenna encapsulated by the first bonding film 2 and the second bonding film, so that the antenna of the instant disclosure does not need to be formed on the printed circuit board or the flexible printed circuit board as conventional antenna, thus reducing the cost of the antenna structure and preventing the environment from pollution. The material cost of the antenna structure of the instant disclosure is lower than the conventional antenna structure, and the antenna structure of the instant disclosure is easily produced by automatic process.

Moreover, the antenna of the instant disclosure can be protected to prevent damage from the external environment (e.g., oxidation) by being encapsulated between the first bonding film and the second bonding film.

Additionally, when the antenna of the instant disclosure is produced as the second embodiment, the manufacturing process of the antenna structure of the instant embodiment is easier than the first embodiment, so that the antenna structure of the instant embodiment can be produced much quicker to reduce the cost.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. An antenna structure, comprising:
a bendable antenna having a main segment, a first connecting segment connected to the main segment, and a second connecting segment connected to the main segment, wherein the antenna has a first surface and an opposite second surface, the first and the second connecting segments are respectively configured for connecting a ground and a signal source;
a bendable first bonding film having an adhesive surface, wherein the first surface of the main segment is adhered on the adhesive surface of the first bonding film; and
a bendable second bonding film having an adhesive surface, wherein the second surface of the main segment is adhered on the adhesive surface of the second bonding film, the adhesive surface of the first bonding film is adhered on the adhesive surface of the second bonding film, and the main segment is encapsulated between the first and second bonding films.

2. The antenna structure according to claim 1, wherein a portion of the adhesive surface of the first bonding film not adhering to the antenna is substantially adhered on a portion of the adhesive surface of the second bonding film not adhering to the antenna.

3. The antenna structure according to claim 2, wherein the first connecting segment has a bonding portion, an externally connecting portion, and a crossing portion connecting the bonding portion and the externally connecting portion, the bonding portion of the first connecting segment is connected to the first surface of the main segment, the crossing portion of the first connecting segment is arranged across the first surface of the main segment, the externally connecting portion of the first connecting segment is exposed from the first bonding film or the second bonding film.

4. The antenna structure according to claim 3, wherein the bonding portion and the crossing portion of the first connecting segment are encapsulated between the first and second bonding films, the antenna has an insulating layer arranged between the crossing portion and a portion of the first surface of the main segment correspondingly overlapping with the crossing portion.

5. The antenna structure according to claim 2, wherein the main segment, the first connecting segment, and the second connecting segment are integrally formed in one piece, the main segment is a planar coil, the first connecting segment is connected to an inner end of the main segment, the first connecting segment is arranged across the first surface of the main segment by bending with respect to the main segment, the second connecting segment is connected to an outer end of the main segment, and wherein a portion of the first connecting segment overlapped with the first surface of the main segment is a crossing portion, the antenna has an insulating layer arranged between the crossing portion and a portion of the first surface of the main segment correspondingly overlapping with the crossing portion.

6. The antenna structure according to claim 4, wherein the insulating layer is formed on a surface of the crossing portion away from the first bonding film, and a portion of the insulating layer contacts the first surface of the main segment, and wherein a portion of the insulating layer not contacting the first surface of the main segment is substantially adhered on the adhesive surface of the second bonding film.

7. The antenna structure according to claim 1, wherein the second connecting segment has a bonding portion and an externally connecting portion integrally extended from the bonding portion of the second connecting segment, the bonding portion of the second connecting segment is connected to the main segment, the externally connecting portion of the second connecting segment is exposed from the first bonding film or the second bonding film.

8. The antenna structure according to claim 7, wherein the main segment, the first connecting segment, and the second connecting segment each has a thickness about 5 to 25 μm, each of the first bonding film and the second bonding film is a heat-resistant plastic film.

9. The antenna structure according to claim 1, wherein the first connecting segment has a bonding portion, an externally connecting portion, and a crossing portion connecting the bonding portion and the externally connecting portion, the bonding portion of the first connecting segment is connected to the main segment, the crossing portion of the first connecting segment is arranged across the first surface of the main segment, and wherein the second connecting segment has a bonding portion and an externally connecting portion integrally extended from the bonding portion thereof, the bonding portion of the second connecting segment is connected to the main segment, the externally connecting portions of the first and second connecting segments are exposed from the first bonding film.

10. The antenna structure according to claim 9, wherein the main segment is a planar coil, the main segment has an inner end and an outer end, the inner end is arranged inside the main segment, the outer end is arranged outside the main segment, and wherein the bonding portion of the first connecting segment is connected to the inner end of the main segment, the externally connecting portion of the first connecting segment is arranged outside the main segment, the bonding portion of the second connecting segment is connected to the outer end of the main segment.
